(19) United States
(12) Patent Application Publication
(10) Pub. No.: US 2002/0185838 A1
(43) Pub. Date: Dec. 12, 2002

(54) Remote control laterally adjustable towing-hitch assembly

(76) Inventors: David Shilitz, Baltimore, MD (US); Louis Toth, West Friendship, MD (US); David M. Hill, Baltimore, MD (US)

Correspondence Address: Law Offices of Royal W. Craig, Suite 153, 10 North Calvert Street, Baltimore, MD, 21202, US

(21) Appl. No.: 10/105,003

(22) Filed: Mar. 21, 2002

Related U.S. Application Data
(63) Continuation-in-part of application No. 10/005,476, filed on Dec. 4, 2001.
(60) Provisional application No. 60/278,031, filed on Mar. 22, 2001.
(60) Provisional application No. 60/251,187, filed on Dec. 5, 2000.
(60) Provisional application No. 60/262,348, filed on Jan. 18, 2001.

(51) Int. Cl. B60D 1/00

(52) U.S. Cl. 280/467; 280/470

(57) ABSTRACT

Disclosed herein is an adjustable tongue assembly for a trailer including an elongate substantially enclosed housing with a lengthwise slot disposed horizontally at the front of the trailer bed. A guide carriage is movably seated in the housing, and the guide carriage is attached to a bracket attached exteriorly of the housing through the lengthwise slot. The guide carriage is journalled to a positioning screw that is rotatably seated lengthwise inside the housing. The positioning screw is coupled to a motor which drives the guide carriage laterally along the internal chamber. A trailer tongue is attached to the external bracket. Selective actuation of the drive motor causes the positioning screw to rotate, thereby moving the roller guide carriage laterally left or right, and thus carrying the bracket and trailer tongue therewith. Lateral adjustment of the device eliminates the need for the lateral element of precision during hook-up, leaving the operator responsible only for the more easily addressed forward and rearward positioning of the vehicle to achieve proper alignment of the trailer and hitch. Further, the invention simplifies backing up with the vehicle/trailer in tandem, and it improves forward maneuverability as the device can be used to cause the trailer to track in the same arc as the turning tow vehicle.

### CROSS-REFERENCE TO RELATED APPLICATIONS

The present application derives priority from U.S. provisional application No: 60/278,031; Filed: Mar. 21, 2001, and is a continuation-in-part of U.S. application Ser. No. 10/005,476, filed Dec. 4, 2001, which in turn derives priority from U.S. provisional applications 60/251,187 filed Dec. 4, 2000, and 60/262,348 filed Jan. 18, 2001.

### BACKGROUND OF THE INVENTION

1. Field of the invention

The present invention relates to trailer hitches, and, more particularly, to a trailer hitch which incorporates a remote control mechanism to facilitate the lateral movement of a linkage assembly. Control over the trailer when backing-up is greatly enhanced by the operator's ability to laterally move the linkage assembly from within the cab of the tow vehicle. Further, the lateral movement compensates for misalignment of the tow vehicle and trailer during hook-up, and improves maneuverability of the vehicle/trailer tandem during forward motion.

2. Description of the Background

There has been a sharp increase in driver preference for sport utility vehicles and pick-up trucks over the past decade, and the increase in demand for more powerful towing capabilities has been commensurate. Tow vehicles are commonly encountered pulling trailers for boats, cars, water-craft, landscaping and lawn-care machinery, livestock, as well as campers, moving trailers, and general purpose trailers. However, the increasing use of trailer hitches by consumers has sensitized them to the hardships which arise from the use of a traditional fixed trailer hitches.

More particularly, great difficulty is sometimes encountered when hooking a trailer to a tow vehicle equipped with a fixed tow hitch. Making the connection between the tow vehicle and the trailer is a difficult procedure because the two units must be precisely aligned to make the proper connection. The difficulty is exacerbated by the fact that the view of the trailer hitch and trailer tongue are usually obscured from view by the rear of the vehicle. Therefore, hook-up is often a two-person operation, carried out with the first person operating the vehicle and the second person, positioned outside of the vehicle with a clear view of the hitch and the trailer, shouting or signaling directional commands to the vehicle operator. The two-person system, however, is prone to error as inevitably the amount of leftward or rightward movement which accompanies the concurrent rearward movement of the vehicle toward the trailer is inadequate for proper alignment of the hitch and tongue. Consequently, the operator is often forced to pull forward and begin the alignment process anew. On an incline, such as a boat ramp, this procedure can be time consuming and hazardous.

Even after they are connected the vehicle/trailer tandem is difficult to maneuver, particularly when backing the trailer. The operator must turn the steering wheel of the tow vehicle in the direction opposite the desired direction of the trailer. Trying to make a tight turn in reverse can result in a “jack-knife”, wherein the tongue of the trailer ends up parallel to the bumper of the tow vehicle, making further backward movement impossible. Even backwards travel in a straight line can be difficult, as for example, when backing a trailer down a narrow boat ramp. In forward travel, tight turns are also difficult to negotiate, because the trailer wheels track inside of the arc taken by the wheels of the tow vehicle. In other words, the tow vehicle makes a “wider” turn than the trailer or conversely the trailer makes a “tighter” turn than the tow vehicle. Maneuverability hardships are exacerbated in small areas where the movements of the towing vehicle are restricted and the handling capabilities are diminished.

There have been efforts as far back as the turn of the century to improve trailer hitches by incorporating lateral movement capabilities into their design. For example, U.S. Pat. No. 1,162,949 to Olson shows a primitive example of a trailer hitch comprising a screw-shaft connected to a bevel gear assembly which enables the operator to laterally adjust the hitch from the operator's seat of the tow vehicle or tractor.

For example, U.S. Pat. No. 1,221,086 to Olson discloses a further refinement to the laterally adjustable trailer hitch, wherein a steering mechanism connected to the front axle of the tow vehicle enables the operator to steer the trailer for improved maneuverability.

U.S. Pat. Nos. 1,235,082 to Von Brethorst, U.S. Pat. No. 1,450,526 to Timmis, and U.S. Pat. No. 2,917,323 to Mandekic further show simple mechanically activated mechanisms employing a horizontally disposed screw-shaft to achieve lateral movement of the trailer hitch.

An improvement to the mechanical devices referenced above is taught in U.S. Pat. No. 3,178,203 to Elliott. Shown is a trailer steering mechanism for the improved steering of a trailer accomplished by incorporating a threaded shaft into the attachment mechanism between the tow vehicle and trailer. In addition, Elliott '203 teaches the use of an electric motor to power the threaded shaft. Operation of the motor is controlled from the cab of the truck by an electrical circuit.

U.S. Pat. No. 5,975,552 to Slaton shows a trailer hitch mounted to a trailer. The hitch comprises a tongue to connect the trailer to a conventional towing ball of a towing vehicle. The trailer hitch includes a winch at one end of the tongue and a winch cable extending from the tongue to the frame of the trailer.

Lacking in the prior art, however, is a towing-hitch assembly powered by an electric motor coupled to a positioning screw via an assembly of ratio gears and powered by a wireless remote control device from the cab of the vehicle. Further, none of the references cited incorporate the screw shaft and its attendant components in an enclosed, protective housing which increases the useful life of the towing-hitch assembly and offers a compact, clean design to satisfy appearance conscious consumers. In light of the foregoing, it would be of great advantage to create an improved adjustable towing-hitch assembly which incorporates these and other advanced features, and which enables the operator of the tow vehicle to laterally adjust the position of the linkage assembly to simplify hook-up and to enhance maneuverability.

### SUMMARY OF THE INVENTION

It is, therefore, an object of the present invention to laterally adjust the linkage assembly of a towing device by connecting said linkage assembly to a motor driven positioning screw.

It is another object to enclose the positioning screw, electric motor, remote sensing unit, and all other internal operating components (to be fully described below) in a sealed housing to protect said components from wear caused by exposure, and to enhance the aesthetic appeal of the device.

It is yet another object of the present invention to control the lateral movement of the linkage assembly by a wireless remote control unit.

A still further object of the invention is to mount the towing-hitch device to the rear of a towing vehicle by means of mounting brackets adaptable for use on a range of different tow vehicles.

It is another object of the present invention to provide an adjustable towing-hitch device which can be connected to the support component of a standard class “A” trailer hitch of the type shown as prior art in U.S. Pat. No. 5,277,447 to Blaser.

A still further object is to mount the towing-hitch device to the frame of a trailer.

According to the present invention, the above-described and other objects are accomplished by providing an adjustable tongue assembly for a trailer (a substantially conventional trailer having a two- or four-wheeled trailer bed). The adjustable tongue assembly includes an elongate substantially enclosed housing disposed horizontally at the front of the trailer bed. The housing defines an internal chamber and is interrupted by a lengthwise slot. A guide carriage is movably seated in the chamber of the housing, and the guide carriage is journalled to a positioning screw that is rotatably seated lengthwise inside the chamber. The positioning screw laterally drives the guide carriage along the internal chamber. A drive motor turns the positioning screw, and this moves the guide carriage. A bracket is attached to the guide carriage externally of the enclosed housing (entering the housing through the lengthwise slot). A trailer tongue is attached to the external bracket. Selective actuation of the drive motor causes the positioning screw to rotate, thereby moving the roller guide carriage laterally left or right, and thus carrying the bracket and trailer tongue therewith.

Lateral adjustment of the device eliminates the need for the lateral element of precision during hook-up, leaving the operator responsible only for the more easily addressed forward and rearward positioning of the vehicle to achieve proper alignment of the trailer and hitch. Further, the invention simplifies backing the vehicle/trailer tandem because the remote control device enables the operator to make fine tuning adjustments to the position of the linkage assembly from within the cab of the tow vehicle. Finally, in forward travel, the invention improves maneuverability as lateral adjustment of the device while the vehicle/trailer tandem is in motion can be used to cause the trailer to track in the same arc as the turning tow vehicle. For example, when making a tight right turn, a rightward movement of linkage assembly (as viewed from behind) causes the trailer to track out a wider arc through the turn than if no adjustment were made.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is an isometric view of a remote control laterally adjustable towing-hitch assembly 2 according to the present invention in which the towing-hitch assembly 2 is mounted to the frame of a trailer.

FIG. 2 is a sectional view of the towing hitch assembly 2 of FIG. 1 showing the trailer tongue 220.

FIG. 3 is a partial isometric view of the telescopically adjustable tongue 220 of the towing-hitch device as shown in FIGS. 1-2.

FIG. 4 is a partial cross-sectional view of the fully assembled towing hitch assembly 2 of FIGS. 1-3.

FIG. 5 is an enlarged view of the roller guide 14.

FIG. 6 is a top plan view of the fully assembled towing-hitch assembly 2 showing the rearward placement of the center positioning lock assembly 16.

FIG. 7 is a sectional view of the drive/motor end-cap 8 as shown in FIG. 1.

FIG. 8 is an alternative embodiment of the drive/motor end-cap 8 wherein the motor 50 engages the positioning screw 10 at a ninety degree angle.

FIG. 9 is a cross-sectional view of the shaft/bearing end cap 6 as shown in FIG. 1.

FIG. 10 is a partial isometric view of an exemplary modification of trailer frame reinforced to accommodate the towing-hitch device 2 of the present invention.

FIG. 11 is a partial isometric view of an alternative embodiment of the towing-hitch device 2 mounted to the modified trailer frame reinforced to accommodate the towing-hitch device 2 of the present invention.

FIG. 12 is a sectional view of the modified trailer frame and towing-hitch device 2 shown in FIG. 10.

### DETAILED DESCRIPTION OF THE PREFERRED EMBODIMENTS

Co-pending application Ser. No. 10/005,476, filed Dec. 4, 2001, discloses an adjustable trailer hitch which provides an operator of a vehicle with improved remote control of the lateral position of the trailer hitch, thereby simplifying the procedure of hooking a trailer to a tow vehicle. The trailer hitch disclosed therein includes a hitch assembly (such as a ball receptacle) attached to a roller carriage which moves from side-to-side along a bumper-like housing mounted on the rear of the tow vehicle. Lateral motion of the ball receptacle assembly is controlled via a wireless remote control unit. During hook-up, lateral movement of the hitch enables the operator to connect the trailer and the tow vehicle from a greater range of positions, and eliminates the need for absolute accuracy of alignment between the tongue of the trailer and the hitch of the tow vehicle as required by traditional fixed hitches.

The present invention accomplishes the very same purposes but modifies the mechanism by moving the operative components onto the trailer rather than the vehicle.

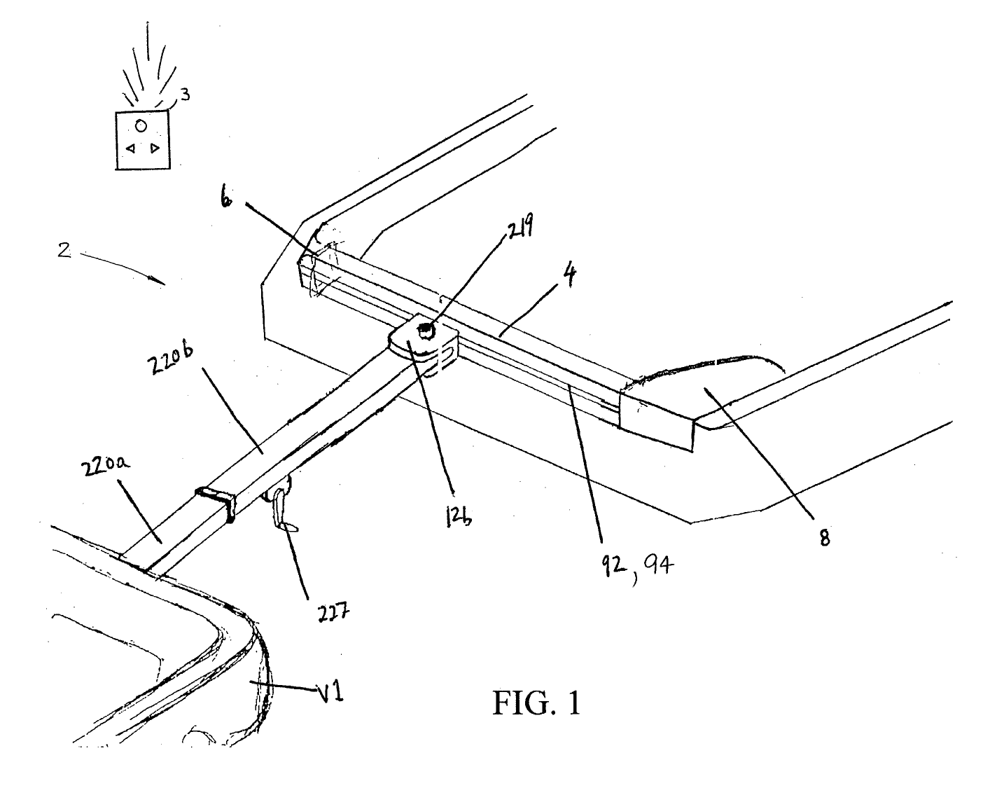

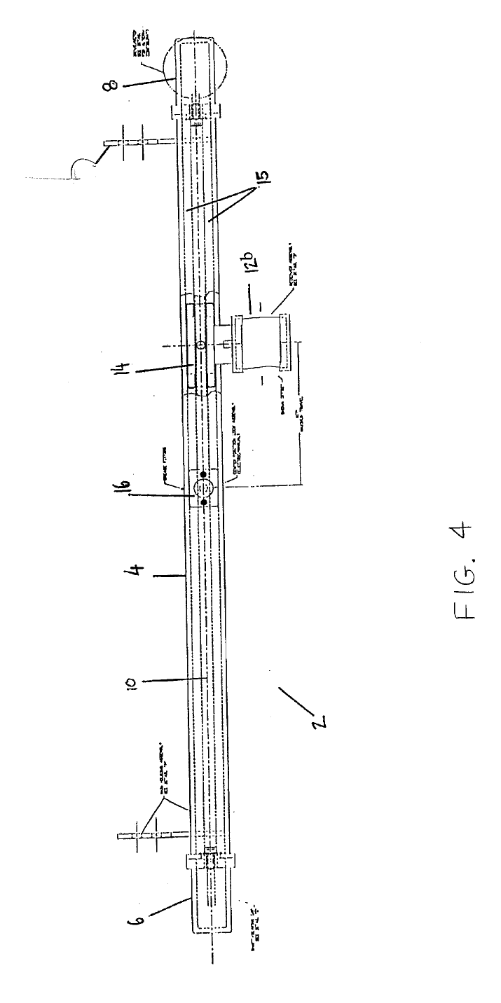

More particularly, as shown in FIG. 1, the towing-hitch assembly 2 according to the present invention comprises an elongate housing structure divided into a central chamber 4 flanked by end-caps 6, 8 all mounted to the frame of an otherwise conventional trailer. The end cap 6 forms a sealed housing for a bushing (or bearings) which seats the distal ends of an elongate positioning screw 10 (enclosed inside chamber 4, see FIG. 4). Opposite end cap 8 forms a sealed housing for an electric motor which drives the positioning screw 10. Positioning screw 10 lies horizontally within central chamber 4 between the bushing and the drive motor. Positioning screw 10 drives a roller guide 14 (also enclosed inside chamber 4, see FIG. 4) which in turn drives a linkage bracket 12b laterally along the outside of central chamber 4.

Central chamber 4 comprises a slotted opening 92 along one face, as seen in FIG. 1. A dust cover 94 comprising a plurality of bristles is installed along the edge of the slotted opening 92 to protect the components within central housing 4.

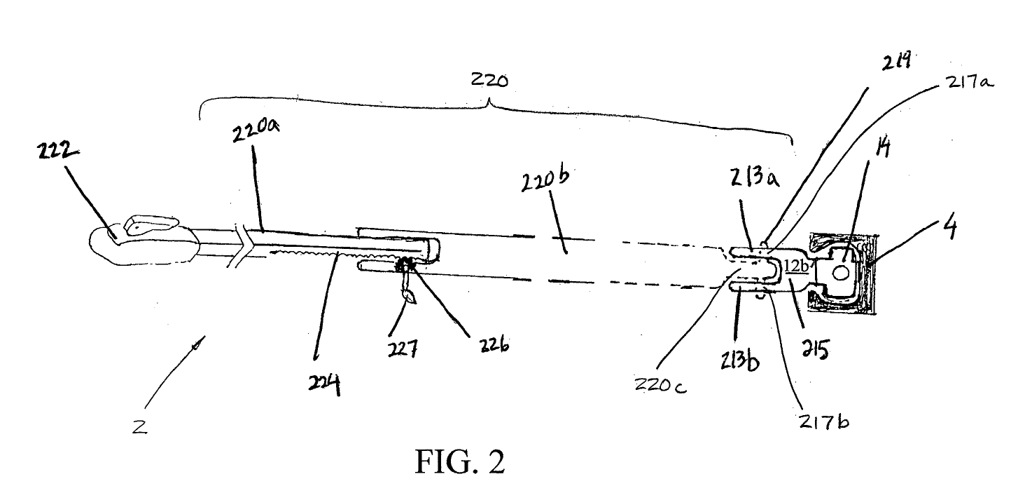

The linkage bracket 12b is connected directly to the roller guide 14 (see FIG. 4) situated within chamber 4. The tongue 220 (see FIG. 2) of the trailer engages attachment bracket 12b. The roller guide 14 and linkage bracket 12b articulate back-and-forth, thereby providing operator control over the lateral position and/or angle of the trailer hitch (obscured) with respect to the tow vehicle V1. Motion of the linkage bracket 12b is controlled by a wireless remote control unit 3. This greatly simplifies the procedure of hooking the trailer to the tow vehicle V1. Specifically, during hook-up of the trailer, lateral movement of the hitch enables the operator to connect the trailer and the tow vehicle V1 from a greater range of positions, thereby eliminating the need for absolute accuracy of alignment between the trailer and the tow vehicle V1 as required by traditional fixed hitches. In addition, the towing-hitch 2 further improves the maneuverability of the vehicle/trailer tandem in transit. In forward motion, the ability to laterally adjust the position of the hitch from within the tow vehicle V1 improves the maneuverability of the rig, as tighter turns may be negotiated by changing the position of the hitch with respect to the tow vehicle V1. Moreover, direct control over the precise lateral position of the trailer hitch enables the operator to accurately steer the trailer when traveling in reverse.

As shown in FIG. 2, linkage bracket 12b comprises a pair of horizontally disposed parallel plates 213a, 213b extending from vertically disposed rear plate 215 away from central chamber 4. Plates 213a and 213b are parallelograms having front, rear, and lateral margins, and each bears a centrally positioned and vertically aligned hole 217a and 217b. Tongue 220 comprises telescoping shafts 220a , 220b, and 220c, each comprising a leading end and a trailing end. Tongue 220 is generally rectangular having top, bottom and side faces. The leading end of shaft 220a carries a conventional hitch-ball receptacle 222. The trailing end of shaft 220c carries pin 219 which engages bracket 12b by passing through central holes 217a and 217b. Immediately forward of bracket 12b, shaft 220b joins shaft 220c in a telescoping configuration. Shaft 220c extends rearwardly from shaft 220b enabling tongue 220 to increase or decrease in length to accommodate the range of dimensions necessitated by the lateral movement of bracket 12b along central chamber 4.

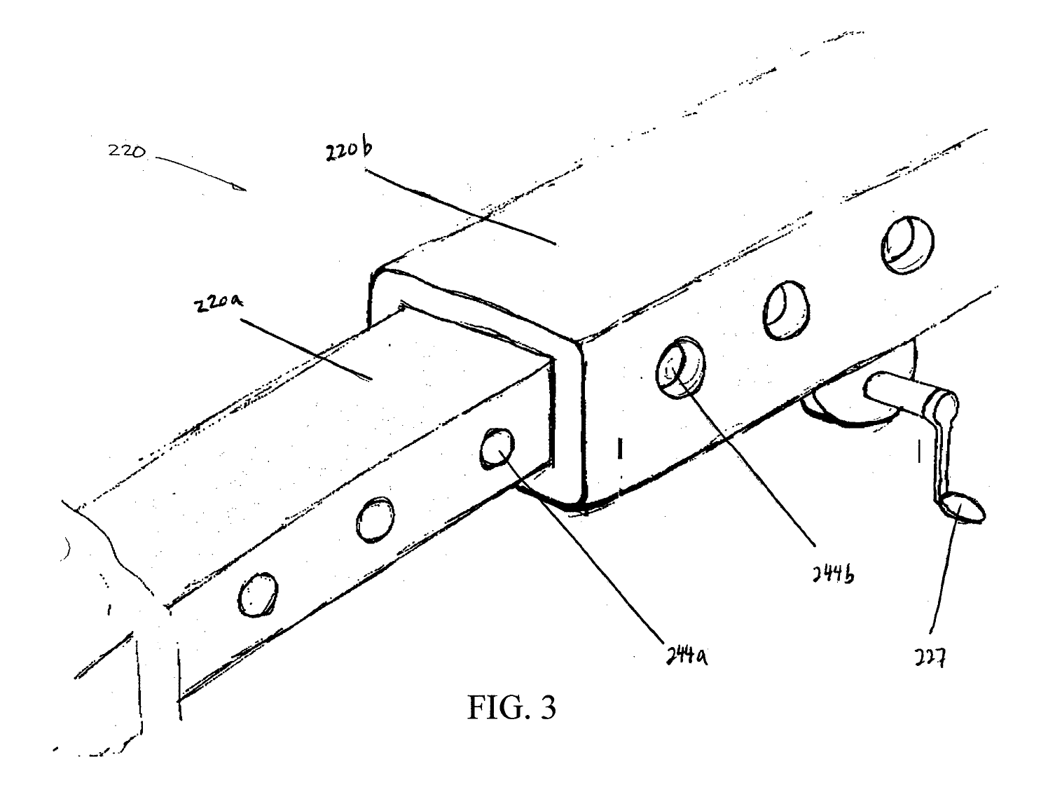

As shown in FIG. 3, the trailing end of shaft 220a telescopes inside the leading end of shaft 220b. Eyelets 244a and 244b are carried on sides of shafts 220a and 220b. When eyelets 244a and 244b are aligned, a conventional locking pin having a terminal securing clip or cotter pin is inserted there through to secure shaft 220a to shaft 220b.

Referring back to FIG. 2, the bottom face of shaft 220a carries teeth 224 engaged by sprocket 226. Sprocket 226 and attached crank 227 are carried on the bottom face of shaft 220b. After removing the securing clip and pin, manually winding crank 227 causes sprocket 226 to engage teeth 224 and telescopically extend or retract shaft 220a. This enables the user to correct forward misalignment of tow vehicle V1 and trailer during hook-up.

FIG.4 is a cross-section of central chamber 4 with roller guide 14 therein, and linkage bracket 12b attached to the roller guide 14.

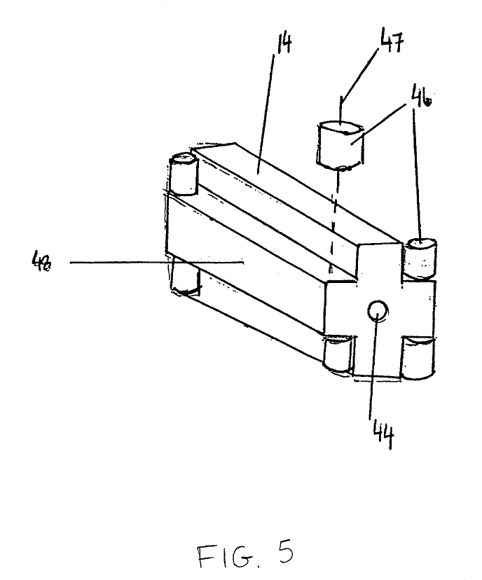

FIG. 5 is a close-up perspective of the roller guide 14. Roller guide 14 comprises a carbon steel position runner 48 having the shape of a three-dimensional cross, and carries a centrally disposed transverse channel 44. Transverse channel 44 is threaded and engages positioning screw 10 as shown in FIG. 4. Roller guide 14 rides on positioning screw 10 as positioning screw 10 turns. Roller guide 14 further comprises pairs of stainless steel wheels 46 which are mounted at the comers of said position runner 48. Four pairs of wheels 46 are thereby attached to the position runner 48. Pins 47 centrally disposed within each steel wheel 46 function as axles for the wheel assemblies.

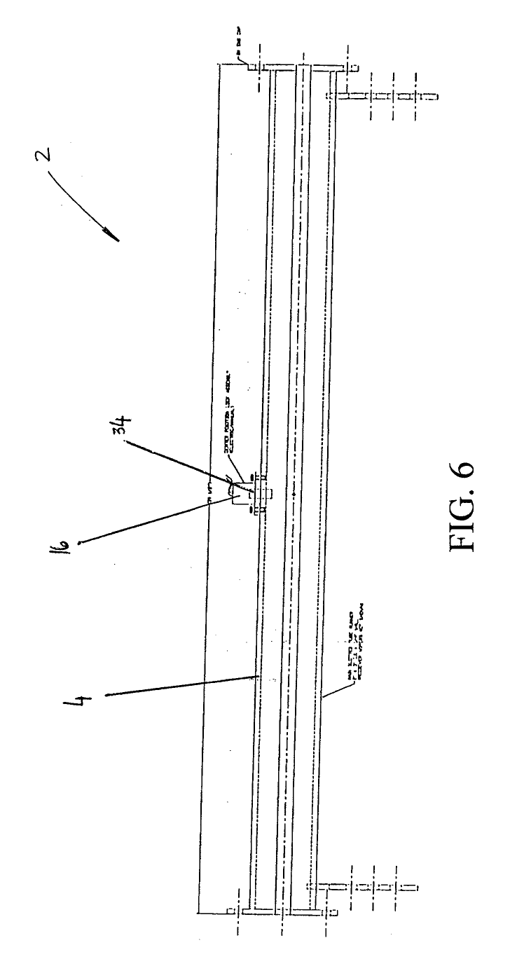

Center position lock assembly 16 visible in FIG. 6 is mounted to the rear face of central chamber 4 and locks linkage bracket 12b (see FIG. 4) in the center position. The locking mechanism 16 prevents lateral movement of linkage bracket 12b during transport. Center position lock assembly 16 comprises a lock which is retracted using an electromagnet and a spring loaded pin 34 to lock when the electromagnet is not energized. In the center position, the electromagnet of the center position lock assembly 16 is de-energized which locks linkage bracket 12b thereby preventing lateral movement.

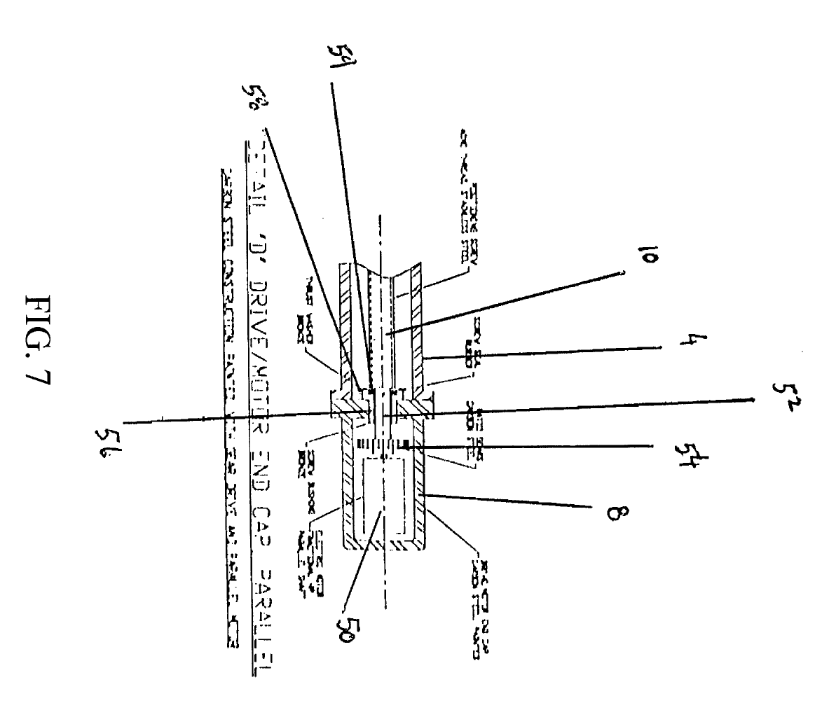

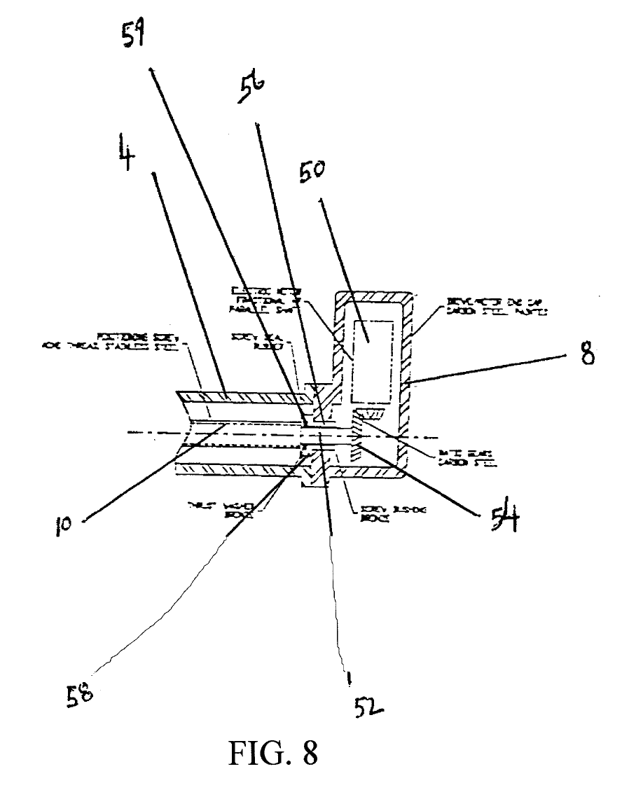

End cap 8 as shown in FIGS. 7 and 8 forms a sealed housing for drive motor 50 and a connection assembly which drive positioning screw 10. As seen in FIG. 7, drive motor 50 lies on the same axis as positioning screw 10. Alternatively, as seen in FIG. 8, drive motor 50 is offset ninety degrees relative to positioning screw 10. A fractional horsepower parallel shaft electric motor provides adequate power for the unit. Alternatively, the motor is hydraulically powered with flexible hydraulic fluid lines linking a control panel within the cab to the drive motor. The connection assembly comprises carbon steel ratio gears 54 directly connected to drive motor 50 and positioning screw 10. Shaft 52 extends from positioning screw 10 from central chamber 4 into end cap 8. Shaft 52 is circumscribed by bronze screw bushing 56 at the junction of central chamber 4 and end cap 8. Bronze thrust washer 58 and rubber screw seal 59 circumscribe positioning screw 10 at its juncture with shaft 52 inside central chamber 4.

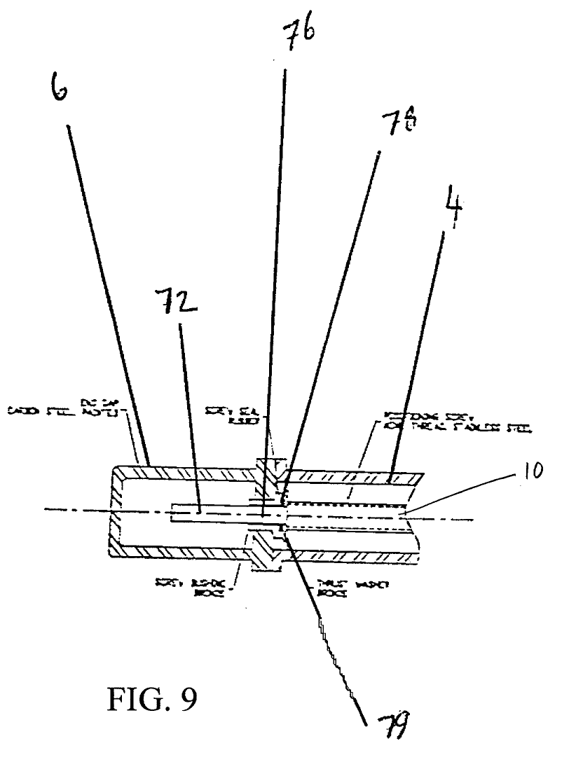

FIG. 9 shows the contents of end cap 6, which forms a seal around shaft 72 of positioning screw 10. Shaft 72 extends into end cap 6 from central chamber 4. Shaft 72 is circumscribed by screw bushing 76 of bronze at the junction of central chamber 4 and end cap 6. Bronze thrust washer 78 and rubber screw seal 79 circumscribe positioning screw 10 at its juncture with shaft 72 inside central chamber 4.

Referring back to FIGS. 1, 4, 6, and 7, a wireless remote control device 3 enables the operator to actuate the drive motor 50. For example, a conventional VHF or infrared Transmitter & Receiver pair are suited to this purpose. The remote 3 may be operated from within the cab of the tow vehicle V1 or from outside. The remote 3 comprises a setting to center linkage assembly 5 and right and left directional buttons. When a directional button is depressed, the locking pin 34 in center position lock assembly 16 is retracted and the motor 50 is energized. Activation of the drive motor 50 causes positioning screw 10 to rotate either clockwise or counter clockwise depending on the input from the operator at the remote control 3. Rotation of positioning screw 10 moves roller guide 14 laterally along the internal track of central chamber 4, thereby effecting lateral movement of linkage assembly 5. The system is effective for simplifying the hook-up process between a tow vehicle V1 and a trailer and can be used while moving at slow speeds to improve maneuverability of the vehicle/trailer tandem.

The system as described herein is preferably powered by the existing automotive 12-volt electrical system. Alternatively, a hydraulic system could be used to achieve lateral movement of the linkage assembly 5. Positioning screw 10 and roller guide 14 are of a stainless steel composition to prevent corrosion.

With all parts assembled as shown in FIGS. 1-9, towing-hitch device 2 is mounted on the frame of an otherwise conventional trailer. A trailer hitch tongue 220 bearing a hitch ball 222 extends from linkage bracket 12b forwardly toward the vehicle V1 as shown. Roller guide 14 is capable of moving laterally inside central chamber 4 along track 15 incorporated therein. Accordingly, any movement of roller guide 14 is translated into movement of linkage bracket 12b. If the hitch ball 222 of the trailer hitch tongue 220 is not attached to the vehicle V1, then movement of linkage bracket 12b is translated into movement of the ball hitch 222 at the end of trailer hitch tongue 220. This greatly simplifies the procedure of hooking the trailer to the tow vehicle V1. If the hitch ball 222 of the trailer hitch tongue 220 is attached to the vehicle V1, then movement of linkage bracket 12b is translated into a change in the angle of tongue 220. This ability to laterally adjust the position of the hitch from within the tow vehicle V1 improves the maneuverability of the rig, as tighter turns may be negotiated by changing the position of the hitch with respect to the tow vehicle V1. Moreover, direct control over the precise lateral position of the trailer hitch enables the operator to accurately steer the trailer when traveling in reverse.

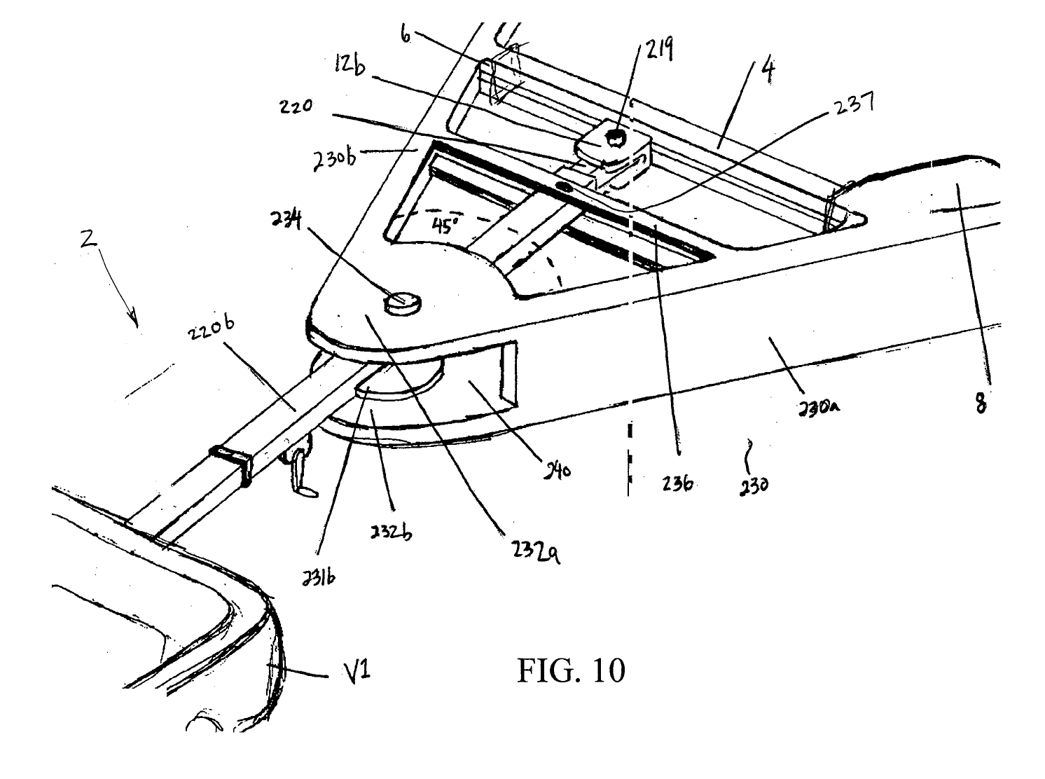

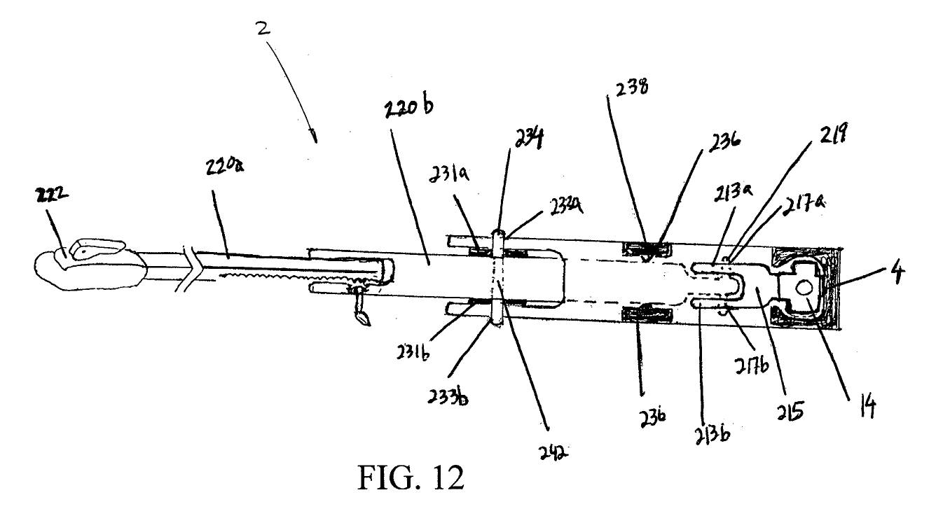

FIG. 10 is an exemplary modification of trailer frame 230 reinforced to accommodate towing-hitch device 2 of the present invention. FIG. 12 is a sectional view of the modified trailer frame and towing-hitch device 2 shown in FIG. 10.

With reference to FIGS. 10 and 12, trailer frame 230 comprises opposing sides 230a and 230b having top, side, and bottom faces configured in a “U” shape. Opposing sides 230a and 230b meet at a point defining the front point of trailer frame 230 at an angle of approximately 45 degrees. The top and bottom faces of opposing sides 230a and 230b meet at parallel plates 232a and 232b respectively. Plates 232a and 232b bear central holes 233a and 233b, which receive pivot post 234. Slot 240 is present at the front point of trailer frame 230. Slot 240 is defined top and bottom by plates 232a and 232b and laterally by the terminal edges of the side faces of opposing sides 230a and 230b. Disks 231a and 231b are positioned in slot 240, and carry holes which align with central holes 233a and 233b on plates 232a and 232b respectively.

A pair of braces 236 extends between opposing sides 230a and 230b rearward of plates 232a and 232b. Braces 236 comprise opposing parallel shafts integrally attached flush with the top face and bottom face of opposing sides 230a and 230b and are evenly spaced apart. Braces 236 bear central holes 237 which receive securing pin 238.

Using the trailer frame as modified above, tongue 220 engages bracket 12b as described above. Tongue 220 extends forwardly from bracket 12b passing through the space defined by braces 236, forward through slot 240, and outwardly beyond trailer frame 230 to the rear of a tow vehicle V1. Pivot post 234 engages tongue 220 via channel 242 in shaft 220b. Pivot post 234 serves as a fulcrum for tongue 220 as it pivots in response to the lateral movement of linkage assembly 5 (see FIGS. 1 or 4). Pivot post 234 further distributes the force, which had before been directed exclusively to bracket 12b, along tongue 220. Disks 231a and 231b support tongue 220, and rotate around the axis of pivot post 234.

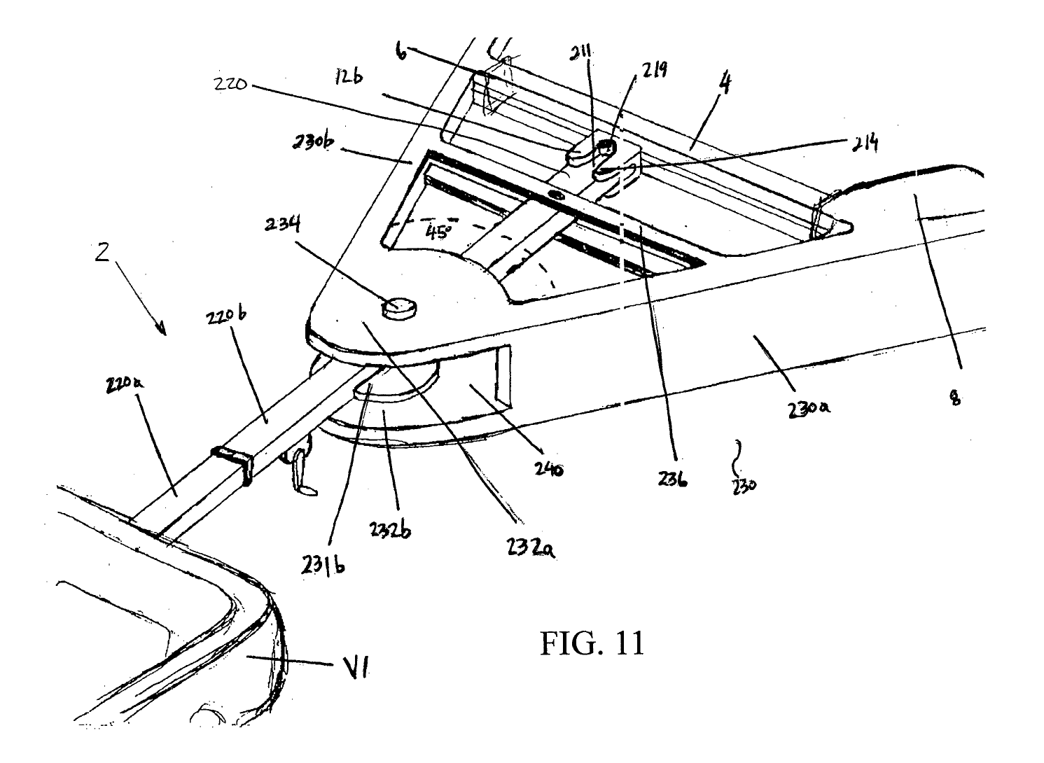

Alternatively, as shown in FIG. 11, each plate 213a and 213b (see FIG. 12) comprises central groove 211 beginning at the open front edge of the plate and joining at rear plate 215 (see FIG. 12). In this embodiment, plates 213a and 213b bear fork-like projections, with central groove 211 flanked on each side and defined by a pair of extensions 214 which project forwardly from rear plate 215. Tongue 220 engages bracket 12b between plates 213a and 213b with pin 219 nestled within groove 211. In this configuration, as bracket 12b moves laterally leftward or rightward, pin 219 moves forward and backward within central groove 211 thereby enabling tongue 220 to accommodate variable shaft lengths.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

We claim:

1. A trailer having an adjustable tongue assembly, comprising:
a wheeled trailer bed;
an elongate substantially enclosed housing disposed horizontally on said trailer bed, said housing defining an internal chamber and being interrupted by a lengthwise slot;
a guide carriage movably seated in said chamber of said housing;
a positioning screw rotatably seated lengthwise inside said enclosed housing and operatively coupled to said guide carriage for laterally driving said guide carriage along said internal chamber;
a drive motor for turning said positioning screw;
a bracket external to said enclosed housing and attached to said guide carriage through said lengthwise slot; and
a trailer tongue attached to said external bracket;
whereby selective actuation of said drive motor causes said positioning screw to rotate, thereby moving said roller guide laterally left or right and carrying said bracket and said trailer tongue therewith.

2. The trailer with adjustable tongue assembly of claim 1, further comprising a ball receptacle assembly mounted distally on said trailer tongue for receiving a trailer hitch ball.

3. The trailer with adjustable tongue assembly of claim 1, wherein said housing comprises a central member having a sealed end cap at each end, said central member being defined by said lengthwise slot.

4. The trailer with adjustable tongue assembly of claim 1, wherein said guide carriage further comprises a plurality of rollers for lateral movement within said enclosed housing.

5. The trailer with adjustable tongue assembly of claim 4, wherein said housing further comprises an internal track along which said guide carriage moves.

6. The trailer with adjustable tongue assembly of claim 5, wherein said guide carriage further comprises a carriage body having a plurality of pairs of stainless steel wheels mounted at a plurality of corners of said carriage body.

7. The trailer with adjustable tongue assembly of claim 6, wherein said carriage body is formed with a cross-shaped cross-section.

8. The trailer with adjustable tongue assembly of claim 7, wherein said positioning screw is a threaded worm gear.

9. The trailer with adjustable tongue assembly of claim 8, wherein said carriage body is formed with a passage for traversal of said positioning screw.

10. The trailer with adjustable tongue assembly of claim 9, wherein the carriage body is formed with internal threads along said passage for engaging the threads of said positioning screw.

11. The trailer with adjustable tongue assembly of claim 8, wherein each end of said positioning screw is seated in one of said end caps, and said positioning screw is connected to said drive motor via a linking assembly.

12. The trailer with adjustable tongue assembly of claim 11, wherein said linking assembly comprises a thrust washer, a screw seal, a screw bushing, and ratio gears.

13. The trailer with adjustable tongue assembly of claim 12, wherein said linking assembly further comprises a shaft set-screwed to said drive motor at one end and set-screwed to said positioning screw at the opposite end, said shaft further comprising interlocking gear teeth on its each end, whereby said shaft engages said drive motor at one end and engages said positioning screw at the opposite end.

14. The trailer with adjustable tongue assembly of claim 1, wherein said drive motor comprises a 12-volt electric motor housed within an end cap of said housing.

15. The trailer with adjustable tongue assembly of claim 1, further comprising a remote control for remotely and selectively actuating said drive motor to rotate in either direction.

16. The trailer with adjustable tongue assembly of claim 15, wherein said remote control comprises an infrared transmitter.

17. The trailer with adjustable tongue assembly of claim 1, wherein said hitch assembly further comprises a trailer hitch tongue with distal ball, said trailer hitch tongue being attached to said guide carriage through said slot in said housing.

18. The adjustable trailer hitch of claim 1, whereby said trailer tongue comprises two telescoping members.
